(19) United States
(12) Patent Application Publication
(10) Pub. No.: US 2013/0119213 A1
(43) Pub. Date: May 16, 2013

(54) Ladder Retaining Apparatus

(71) Applicant: Tom Watson, Scituate, MA (US)

(72) Inventor: Tom Watson, Scituate, MA (US)

(21) Appl. No.: 13/614,054

(22) Filed: Sep. 13, 2012

Related U.S. Application Data
(60) Provisional application No. 61/534,265, filed on Sep. 13, 2011.

(51) Int. Cl. E06C 7/42

(52) U.S. Cl. CPC E06C 7/42
USPC 248/201

(57) ABSTRACT

A versatile system and apparatus for securing a ladder in an operational position by restraining the base of the ladder is presented. The system features a substantially rectangular retaining mechanism, wherein the legs of the ladder are placed within the substantially rectangular retaining mechanism, and a locking mechanism for affixing the substantially rectangular retaining mechanism to a work surface. The locking mechanism may comprise at least one channel in the base of the substantially rectangular retaining mechanism, and at least one anchoring bracket, wherein the anchoring bracket is removably attached to the substantially rectangular retaining mechanism via the channel. The locking mechanism may also comprise at least one aperture in the base of the substantially rectangular retaining mechanism, and at least one stake mechanism, wherein the stake mechanism is driven through the aperture and into a work surface.

### CROSS REFERENCE TO RELATED APPLICATION

This application claims the benefit of and takes priority from U.S. Application No. 61/534,265 filed on Sep. 13, 2011, the contents of which are hereby incorporated by reference.

### BACKGROUND OF THE INVENTION

### Field of the Invention

The invention generally relates to ladder securing devices, and more particularly, to devices intended to stabilize the base of a ladder when the ladder is in operation.

Ladders are extremely useful devices, yet inherently dangerous. When extended, the top of the latter can sway left or right, causing the operator to fall. Similarly, if not properly supported, the base of a ladder can slip or shift, causing a loss of stability. Injuries sustained from ladder accidents can be quite severe. Those who fall from a ladder may suffer bruises, broken bones, or a life-threatening injury.

The legs at the base of a ladder typically have feet designed to prevent the base of the ladder from shifting when in operation. Depending on the substrate used or angle of the ladder, the ladder feet may still slip. Enhanced safety may be provided by securing the base of the ladder by placing it against a block of wood that has been secured to the ground. Disadvantageously, the block of wood may break after repeated uses, which would be disastrous for the operator if it occurred while the ladder was in use. A block of wood also fails to prevent the ladder from experiencing lateral movement.

### SUMMARY OF THE INVENTION

The instant apparatus and system, as illustrated herein, is clearly not anticipated, rendered obvious, or even present in any of the prior art mechanisms, either alone or in any combination thereof. A versatile ladder box for securing the base of a ladder to a variety of surfaces is presented. Thus the several embodiments of the instant apparatus are illustrated herein.

It is therefore an object of the present system, in one example, to provide a stable support mechanism for the base of a ladder.

It is another object of the invention to provide a ladder support mechanism that is versatile and easy to use.

It is another object of the invention to provide a ladder support mechanism that is durable and reusable.

It is another object of the invention to provide a ladder support mechanism that allows for the use of a ladder at a variety of angles.

It is another object of the invention to provide a ladder support mechanism that can be used on a variety of ground surfaces.

It is another object of the invention to provide a ladder support mechanism that can be used on surfaces of varying angles.

The invention results, in one example, from the realization that the problem of safely securing the base of a ladder to a variety of surfaces is solved by a ladder foot containment box that can be safely secured to a variety of ground surfaces.

The invention features a box, wherein the legs of the ladder are placed within the box, and a securing means for affixing the box to a work surface. The securing means may comprise at least one cut slotted channel in the base of the ladder box, and at least one anchoring bracket, wherein the anchoring bracket is removably attached to the ladderbox via the cut slotted channel. The anchoring bracket may be removably attached to the cut slotted channel with a bolt. The securing means may also comprise at least one hole in the base of the ladder box, and at least one stake mechanism 99, wherein the stake mechanism is driven through the hole and into a work surface. The stake mechanism 99 may be selected from a group consisting of screws, double headed nails, anchoring bolts, and railroad tie spikes. The ladder box may feature a serrated or rubberized material on either the top or bottom of the box. The ladder box may further comprise a front wall member, a rear retaining wall member, and side wall members, wherein the legs of a ladder are secured by placing them against the rear retaining wall member.

There has thus been outlined, rather broadly, the more important features of the ladder box embodiments in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty, which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

To the accomplishment of the foregoing and related ends, certain illustrative aspects are described herein and these aspects are indicative of the various ways in which the principles disclosed herein can be practiced and all aspects and equivalents thereof are intended to be within the scope of the claimed subject matter.

### BRIEF DESCRIPTION OF THE DRAWINGS

Advantages of the present apparatus will be apparent from the following detailed description of exemplary embodiments thereof, which description should be considered in conjunction with the accompanying drawings, in which: Having thus described the invention in general terms, reference will now be made to the accompanying drawings, which are not necessarily drawn to scale, and wherein:

FIG. 1 depicts a perspective view of an embodiment of the present invention.

FIG. 2 depicts a top perspective view of another element of an embodiment of the present invention.

FIG. 3 depicts a perspective view of an anchoring bracket used in an embodiment of the present invention.

FIG. 4 illustrates the use of an embodiment of the present invention on a decking surface.

FIG. 5 further illustrates the use of an embodiment of the present invention on a decking surface.

FIG. 6 illustrates two embodiments of the stake mechanism.

### DETAILED DESCRIPTION OF THE PREFERRED EMBODIMENTS

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

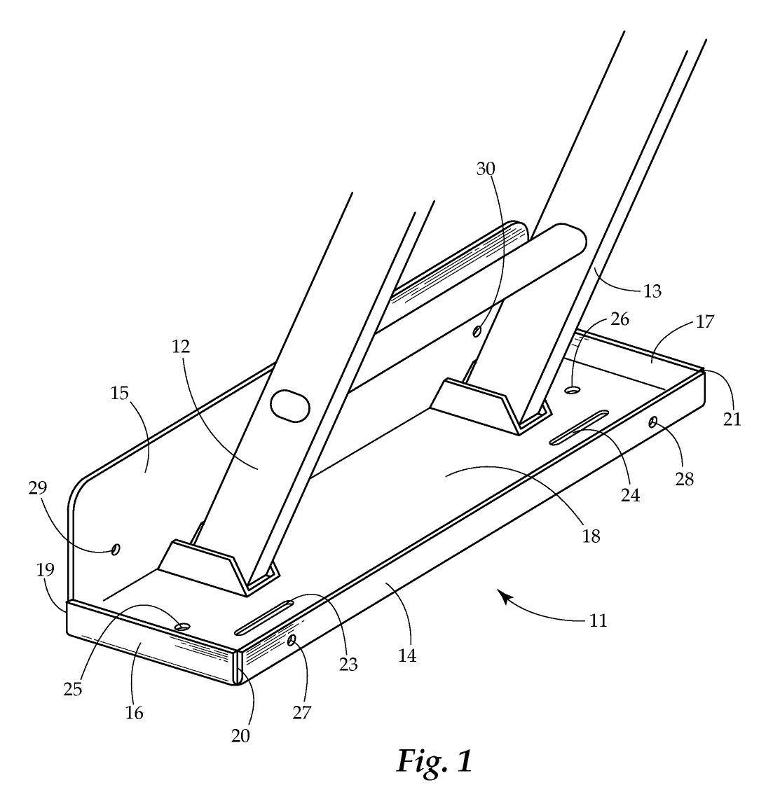

FIG. 1 illustrates an embodiment of the instant invention. Ladder box, ladder base securing apparatus or ladder retaining apparatus 11 comprises a substantially rectangular framework and base of sufficient dimensions to accommodate the legs 12, 13 of a ladder 5. In one embodiment, Ladder box, ladder base securing apparatus or ladder retaining apparatus 11 comprises a front wall member 14 of 2×28 inches dimension, a rear retaining wall member 15, in one embodiment, of 6×28 inch dimension, side wall members 16, 17, in one embodiment, of 2×8 inches dimension, and a base 18 of 8×28 inch dimension. The box is formed from a single sheet, in one embodiment, of ⅛ inch aluminum metal plate that is bent to form the box structure and mechanically joined by welding at the corners 19, 20, 21, 22.

In one embodiment, the rectangular box 11 is also fitted with two cut slotted channels 23, 24 that, in one embodiment may be 5/16 inch wide, 5 inches long, located 2 inches from the front wall 14 of the box, and begin approximately 2 inches from the side walls 16, 17. In one embodiment, there are two ⅝ inch drilled holes 25, 26 that are located approximately midway between the front 14 and rear 12 walls of the box and 2 inches from the side walls of the box. In one embodiment, there are also two ¼ inch holes 27, 28 that are located on the rear retaining wall 14 approximately 2 ¼ inches above the base of the wall and in one embodiment, there approximately 4 inches from the side walls 16, 17 of the box. The top corners 31, 32 of the rear wall member are rounded with a 1 inch radius.

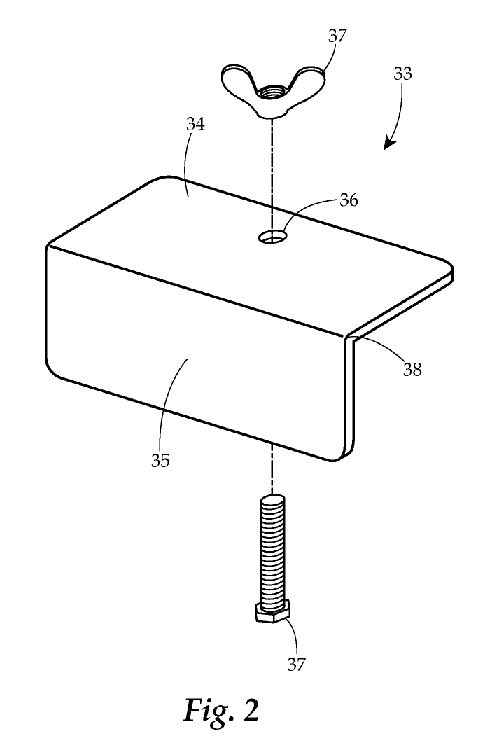

FIG. 2 depicts a top perspective view of another element of the present invention, which is an anchoring bracket 33 comprised of a top plane 34, which in one embodiment may be 3×6 inch dimensions, and a side plane 35 which in one embodiment may be 3×6 inch dimension. The top plane 34 has, in one embodiment, there a ¼ inch drilled hole 36 that is centered longitudinally and in one embodiment, located 2 inches from the lateral bend 38 to accommodate a bolt and lock nut or wing nut 37 which is used to attach the anchoring bracket to the base of the ladder box through the slotted channels 23, 24 of FIG. 1. The four corners of the anchoring bracket are rounded with a ½ inch radius. The preferred mode of manufacture is accomplished by bending a 6×6 inch plate of ⅛ inch aluminum along line 38 at a right angle. Referring to FIG. 1, for ease of storage the anchoring brackets may be attached to the rear wall of the ladder box at holes 29 and 30.

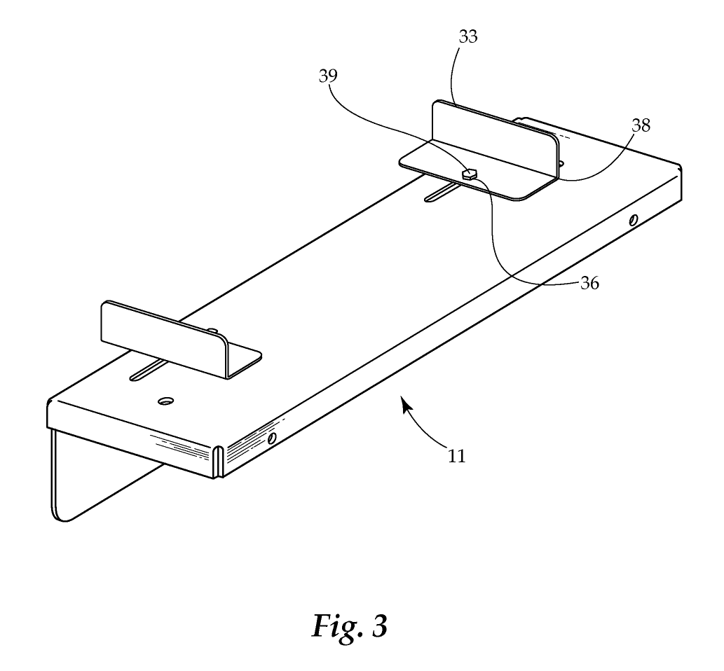

FIG. 3 depicts a perspective view of the anchoring bracket 33 from the underside illustrating the position of the flat-headed bolt 39 as inserted into the ⅜ inch drilled hole 36 that is centered longitudinally and located 2 inches from the lateral bend 38.

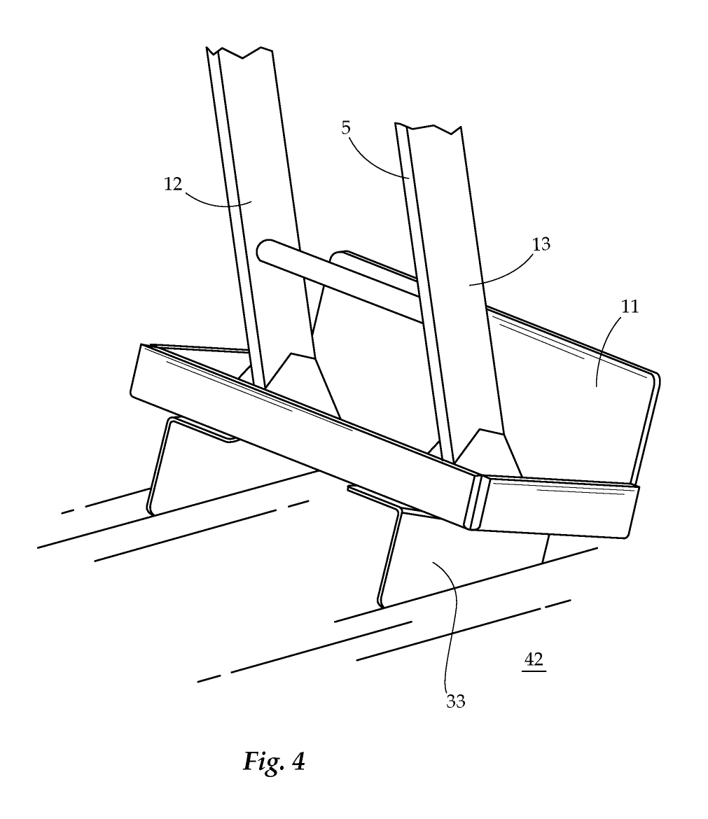

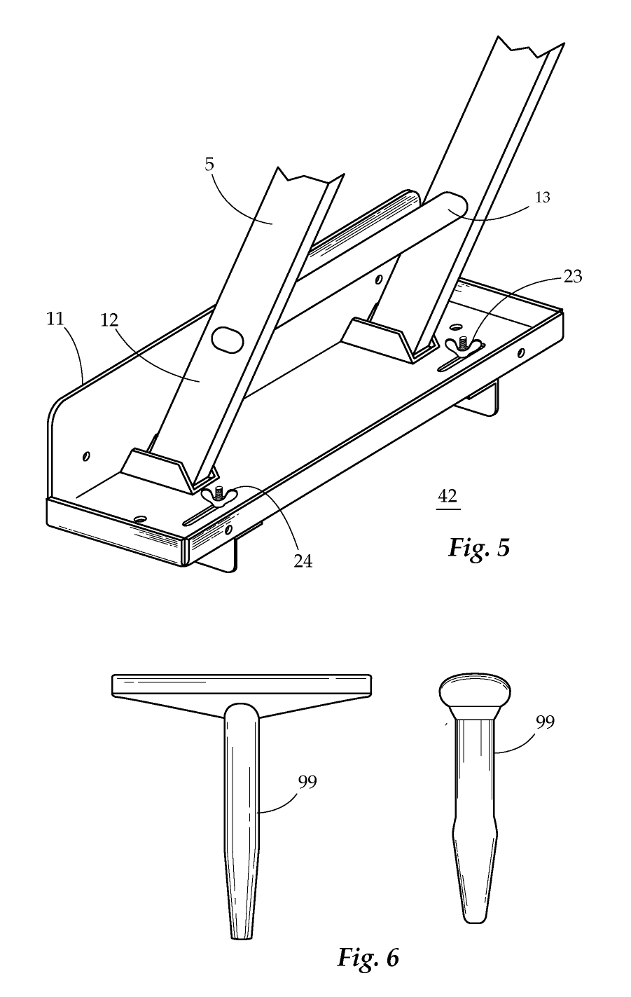

FIGS. 4 and 5 illustrate the operation of the ladder box 11 in operation on a decking surface 42. In operation, one uses the ladder box 11 by attaching the angular anchoring brackets 33 to the underside of the rectangular box 11 with the use of flat headed bolts 39 placed up through the bracket 33 and then through the underside of the rectangular box at the slotted openings 23, 24. The attached brackets 33 are then inserted into the grooves 44 between the decking materials upon which the ladder is to be used. If the decking is constructed with the planking laid perpendicular to the face of the surface to be worked upon, the position of the brackets 33 can be adjusted within the slotted channels 22, 23 to accommodate varying widths of the underlying joists.

Once the ladder box is secure, a ladder is then inserted into the rectangular box 11 with the legs 12 13 resting against the rear retaining wall member 15 and top of the ladder is then placed against the work surface. The ladder box 11 is held stationary on the deck surface 42 when the rearward edge of the angular brackets 33 come into contact with the underlying joists supporting the deck in the case that the decking material is perpendicular to the plane of the work surface and the underlying joists are parallel to the work surface. In the event that the decking material is applied parallel to the face of the work area, the angular brackets 33 are adjusted to be inserted in the same manner so that the ladder box is held stationary by the lateral face of the anchoring brackets between the underlying joists.

The ladder box is versatile and can be used to secure the base of a ladder on a variety of surfaces, including the utilization of the ladder box 11 on grass 50, concrete 52, or gravel 54. Referring to FIG. 1 and FIG. 6, on such bare ground surfaces, the ladder box may be secured by utilizing a stake mechanism 99, such as driving railroad tie spikes of dimensions 6 to 12 inches through holes 25, 26 in the base of the ladder box and into the ground. The ladder box 11 may also be fastened to solid wood surfaces utilizing screws or double headed nails through the pair of 5/16 inch holes 27 and 28. It may also be used on concrete surfaces by anchoring bolts through the pair of holes 27 and 28.

Ladders that are not oriented substantially level are safety hazards, as they can easily fall to the side and cause injury to the operator. However, often work surfaces are not level. The ladder box 11 may be utilized on uneven work surface 60. First, wood planks 62 of 2×4 inch dimension are secured to the uneven work surface such that the ladder box 11 is substantially level when placed on top. The ladder box 11 is then fastened to the wood planks 62 and surface 60 using screws or double headed nails through the pair of holes 27 and 28.

The instant system may also to safely secure ladders at very low angles. Normally, ladders cannot safely be used at a low angle 70 because the base would slip when the ladder is used. The ladder box 11 can secure the ladder and protect the operator from injury even when used at a low angle.

In conclusion, herein is presented a versatile box for securing a ladder. The invention is illustrated by example in the drawing figures, and throughout the written description. It should be understood that numerous variations are possible, while adhering to the inventive concept. Such variations are contemplated as being a part of the present invention.

What is claimed is:

1. A ladder retaining apparatus, comprising:
a retaining mechanism disposed to receive at least one set of ladder leg mechanisms and restrain the set at least one set of ladder leg mechanisms in at least one degree of freedom; and
a locking mechanism for affixing a bottom portion of each of the at least one set of ladder leg mechanisms to the substantially rectangular retaining mechanism and to a work surface.

2. The ladder retaining apparatus of claim 1, wherein the locking mechanism comprises:
at least one slotted channel disposed in a base of the retaining mechanism;
a fastening mechanism; and,
at least one anchoring bracket, wherein the anchoring bracket is removably attached to the ladder box via the slotted channel.

3. The ladder retaining apparatus of claim 2, wherein the anchoring bracket is removably attached to the slotted channel with a bolt.

4. The ladder retaining apparatus of claim 2, wherein the anchoring bracket is pivotally attached to the slotted channel.

5. The ladder retaining apparatus of claim 1, where the securing means comprises:
at least one aperture in the base of the ladder retaining apparatus; and
at least one stake mechanism, wherein the stake mechanism is driven through the aperture and into a work surface in order to retain the ladder retaining apparatus and the ladder in a stable position.

6. The ladder retaining apparatus of claim 5, where the stake mechanism is selected from the group consisting of screws, double headed nails, anchoring bolts, and railroad tie spikes.

7. The ladder retaining apparatus of claim 1, wherein the surface of the ladder retaining apparatus is coated with a serrated or rubberized material to better secure the ladder.

8. The ladder retaining apparatus of claim 1, wherein the bottom of the box is composed of a serrated or rubberized material to better secure the box.

9. The ladder retaining apparatus of claim 1 wherein the retaining mechanism is substantially rectangular.

10. The ladder retaining apparatus of claim 1 wherein fastening mechanism further comprises a set of threads.

11. The ladder retaining apparatus of claim 10 wherein the fastening mechanism further comprises a lock nut mechanism disposed to ride the set of threads.

12. A ladder base securing apparatus comprising:
a rectangular base disposed to enclose the lower portions of the legs of a roofing ladder;
at least one cut slotted channel in the base;
at least one angular bracket, wherein the bracket may be affixed at a variety of angles to the base by securing it to the slotted channel.

13. The ladder base securing apparatus of claim 12, wherein the rectangular base further comprises:
a front wall member;
a rear retaining wall member; and
side wall members.

14. The ladder base securing apparatus of claim 12, wherein the legs of a ladder are secured by placing them against the rear retaining wall member.

15. A ladder box for securing the base of a ladder, comprising:
a rectangular base of sufficient dimensions to accommodate the legs of a ladder;
at least one opening in the base; and
at least one stake mechanism, wherein the stake mechanism is driven through the opening and into a work surface.

16. The ladder box of claim 15, wherein the stake mechanism is selected from the group consisting of screws, double headed nails, anchoring bolts, and railroad tie spikes.
